(19) United States
(12) Patent Application Publication
(10) Pub. No.: US 2012/0222352 A1
(43) Pub. Date: Sep. 6, 2012

(54) Growth device for crop and cladding or construction part manufactured therewith

(75) Inventor: Hendrikus Wilhelmus Theodorus Janssen, Malden (NL)

(73) Assignees: Dartdijk N.V., Leersum (NL); Hervorma B.V., Malden (NL)

(21) Appl. No.: 13/393,208

(22) PCT Filed: Aug. 28, 2009
(86) PCT No.: PCT/NL2009/050517

§ 371 Date: May 15, 2012

(51) Int. Cl. A01G 9/02; A01G 25/00; B23P 17/04; A01G 31/02

(52) U.S. Cl. 47/65.7; 47/65.5; 47/59 S; 47/79; 29/592

(57) ABSTRACT

The invention relates to a growth device for crop, provided with at least a casing and a core part, wherein the casing is substantially manufactured from fluid impermeable material and surrounds the at least one core part at least partly, wherein the core part comprises a growth medium or is formed therefrom. The invention further relates to an assembly of at least two of such growth devices, a cladding or construction part comprising such growth device and a method for the manufacture of growth devices.

The invention relates to a growth device for crop. Growth devices for growing crop are known. For instance, grow mats are used for growing plants. Such grow mats comprise a strip of water-absorbing rock wool, enclosed by a tube of plastic foil. In the foil, openings are provided in a top side, where plants can be placed. As the rock wool is water-retentive to some extent, the roots of the plants are kept moist, which stimulates growth. Furthermore, growing substances can be supplied in a simple manner. Such grow mats are to be laid down flatly, with the openings towards the top.

The object of the invention is to provide an alternative growth device. The object of the invention is in particular to provide a growth device that can simply be used on inclining or even vertical planes, whereby crop can be provided on an inclining or vertical side.

Another object of the invention is to provide a growth device which can have an insulating function and can furthermore be decorative owing to crop growing therein.

Yet another object of the invention is to provide a growth device which can be fastened to a façade or wall and is provided with watering means.

These and other objects are achieved with a growth device according to the specification.

In a first aspect, a growth device for crop according to the specification is characterized in that it is provided with at least a casing and a core part, the casing, at least part of the casing enclosing the core part, being manufactured from a substantially fluid impermeable material. The at least one core part is at least largely surrounded by the casing, while the core part comprises a growth medium or is formed therefrom. The fluid impermeable material may for instance be at least one of foamglas, polystyrene, polyurethane, polyisocyanurate and plastic, for instance polyester, polyethylene, polyvinyl chloride and the like materials. In another embodiment of the invention, the casing may only comprise a substantially fluid impermeable material at a surface and/or wall enclosing the core part. The part of the casing facing away from the core part may for instance be of another material, such as a material having good insulating properties, a material that is gas permeable or having other properties. The fluid impermeable material can be defined as material that is at least impermeable to a fluid such as a liquid like water or to a vapour. In another embodiment of the invention, the casing may be substantially manufactured from stone, concrete, clay or the like material, wherein the part of the casing enclosing the core part may be provided with a layer of fluid impermeable material, for instance by means of a sealing layer of a suitable material.

By providing the casing of a substantially fluid impermeable material, the growth device can be used to advantage on different locations, for instance on substantially inclining surfaces such as roofs and the like. The device may also be used on surfaces of inner walls for instance inside buildings. Due to such a construction of the growth device, the risk of fluid such as water, for instance due to rain or watering of the plants, ending up between the growth device and the opposite surface may be minimized or prevented.

In further elaboration of the invention at least one wall of the casing may be provided with at least one opening which extends to near and/or into the at least one core part. Via such an opening a plant, or at least the roots of the plant, can be inserted in the core part.

The applicant has surprisingly found that due to the fact that the core part is in fluid connection with the growth device surroundings via the at least one opening in the casing, the roots of the plants or crop may be provided with sufficient oxygen to stimulate growth despite the fluid impermeable casing material.

To further increase the oxygen supply to the roots, a through hole may be provided in the wall of the casing, wherein a central axis of the through hole extends at an angle with respect to the casing wall such that in use a first end of the through hole facing away from the core part is located above a second end of the through hole facing the core part. Such through holes may be micro holes having a very small diameter and may be intended to be gas permeable. Due to the position at an angle with respect to the casing wall, water flowing in a downward direction through the core part will not likely flow through the through hole in an upward direction. Consequently, the outer surface of the casing remains dry.

In another aspect, the invention is characterized in that a top side and a bottom side are provided, wherein adjacent the top side at least a part of the at least one core part is accessible to water. At the bottom side, at least one water discharge opening is provided for discharge of water from the at least one core part. Return means are provided for returning to adjacent the top side to the core part, water collected at the water discharge opening.

In still a further aspect, the invention is characterized in that an assembly of at least two growth devices is provided, wherein core parts of the respective growth devices are in communication with each other such that water can flow from one of the core parts into at least one other core part.

In still another aspect, the invention is characterized by a cladding or construction part, comprising at least one growth device according to the invention.

In yet another aspect, the invention is characterized by a method for manufacturing a growth device, wherein a core part is manufactured from a somewhat hydrophilic material, which core part is at least partly surrounded by a casing which is, at least partly manufactured from a substantially fluid impermeable material.

By way of illustration, embodiments of a growth device, assembly, cladding, construction part and method according to the invention will be further elucidated on the basis of the drawing. In the drawing:

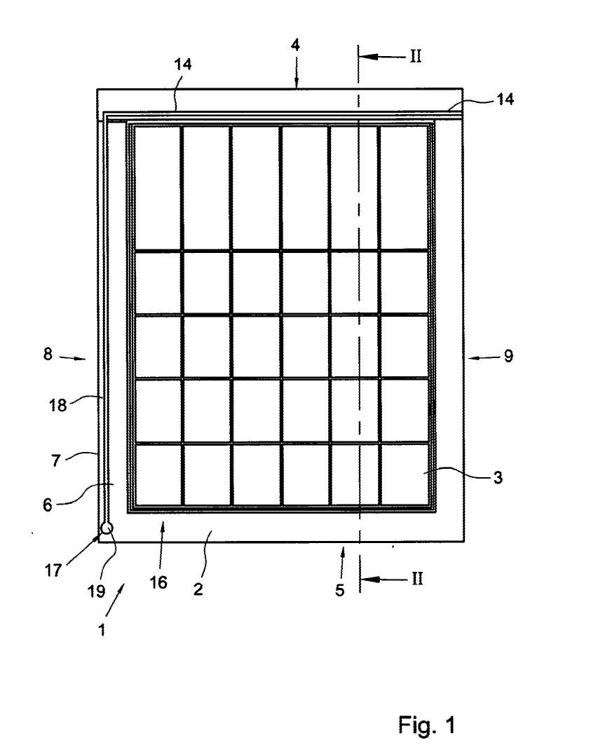

FIG. 1 schematically shows, in front view, a growth device according to the invention;

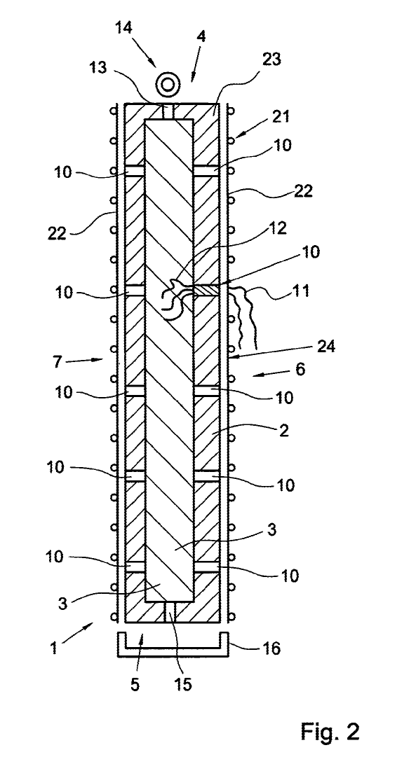

FIG. 2 schematically shows, in cross sectional side view according to the line II-II in FIG. 1, a growth device;

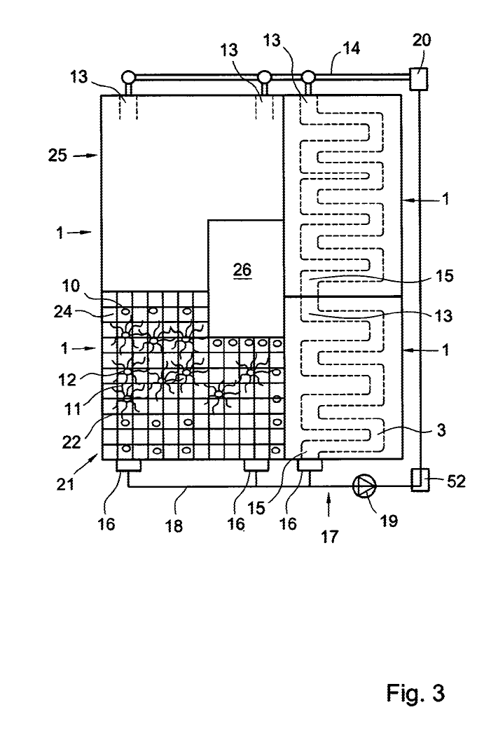

FIG. 3 schematically shows a façade cladding comprising an assembly of a number of growth devices according to FIG. 1;

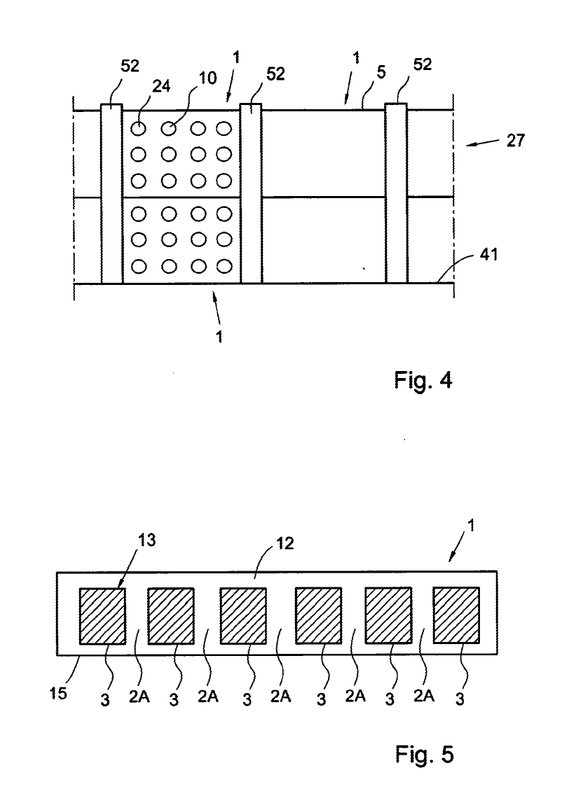

FIG. 4 schematically shows an assembly of a construction part comprising a number of growth devices according to FIG. 1;

FIG. 5 schematically shows a growth device, in top plan view in an alternative embodiment;

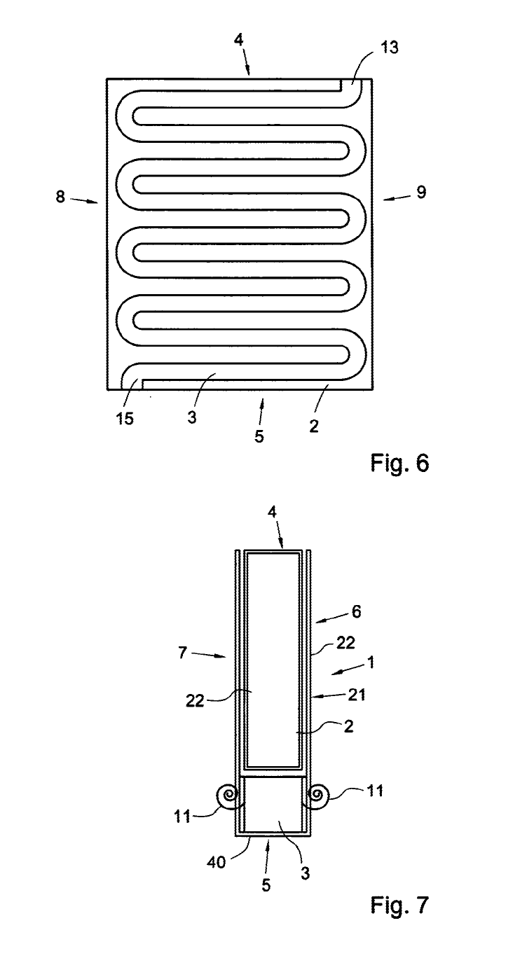

FIG. 6 schematically shows, in cross sectional front view, a further alternative embodiment of a growth device and in particular core parts thereof;

FIG. 7 schematically shows, in cross sectional side view, a still further alternative embodiment of a growth device according to the invention;

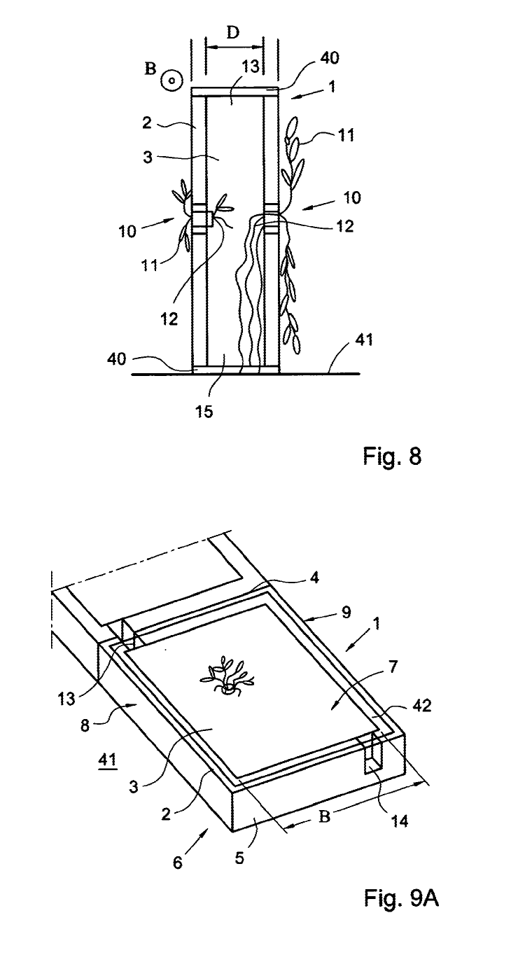

FIG. 8 schematically shows, in cross sectional side view, a further alternative embodiment;

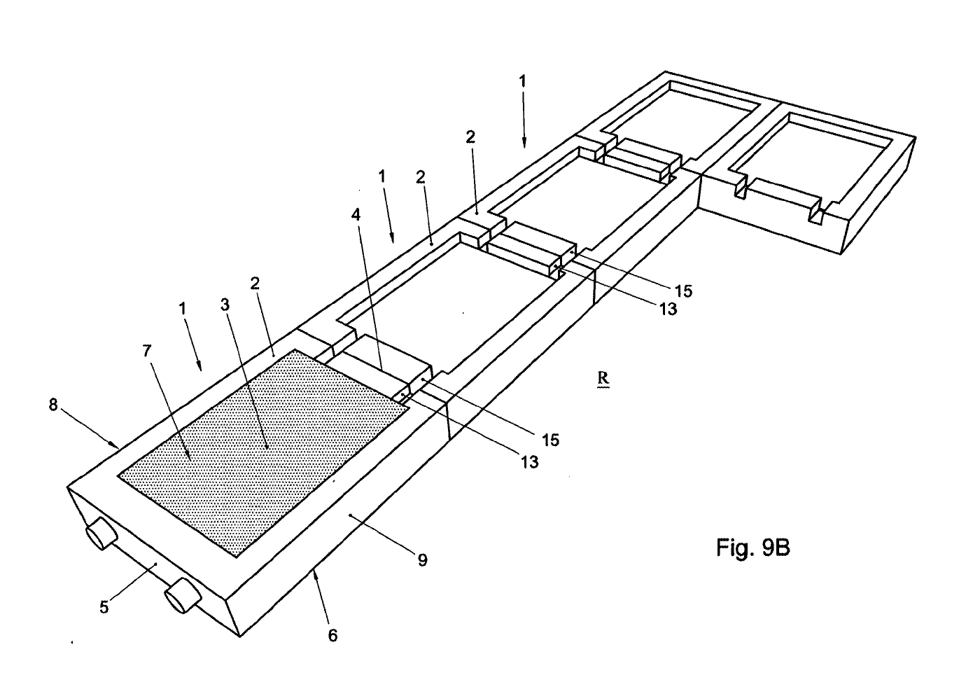

FIG. 9A schematically shows, in perspective view, a growth device in a still further alternative embodiment;

FIG. 9B schematically shows, in perspective view, a growth device in a still further alternative embodiment;

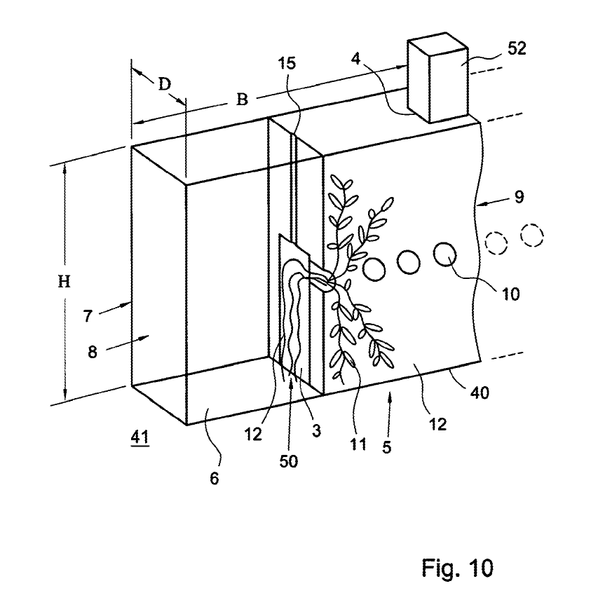

FIG. 10 shows, in perspective view, a further alternative embodiment, partly in phantom image;

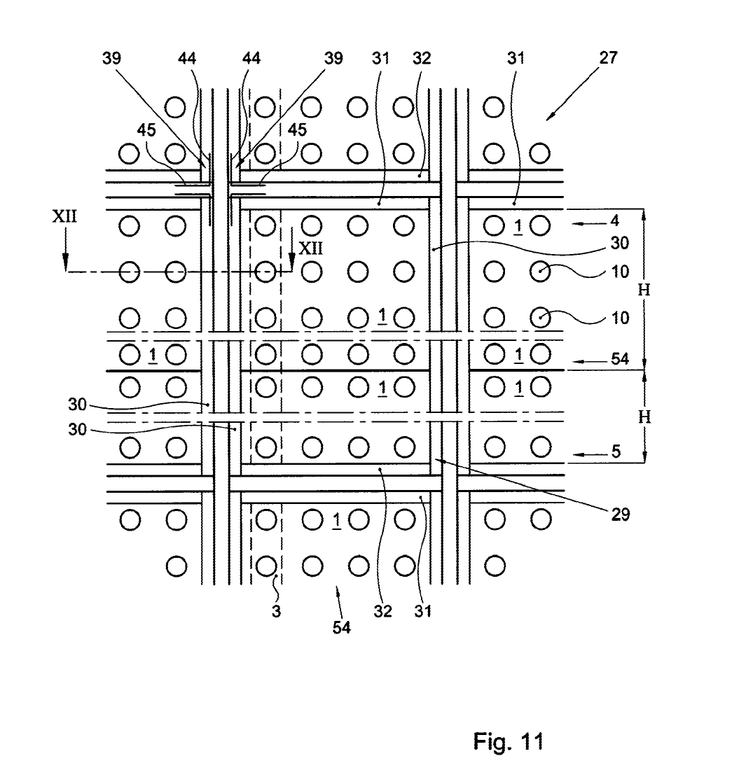

FIG. 11 shows, in front view, a portion of an alternative embodiment of a wall built up from or clad with growth devices according to the invention;

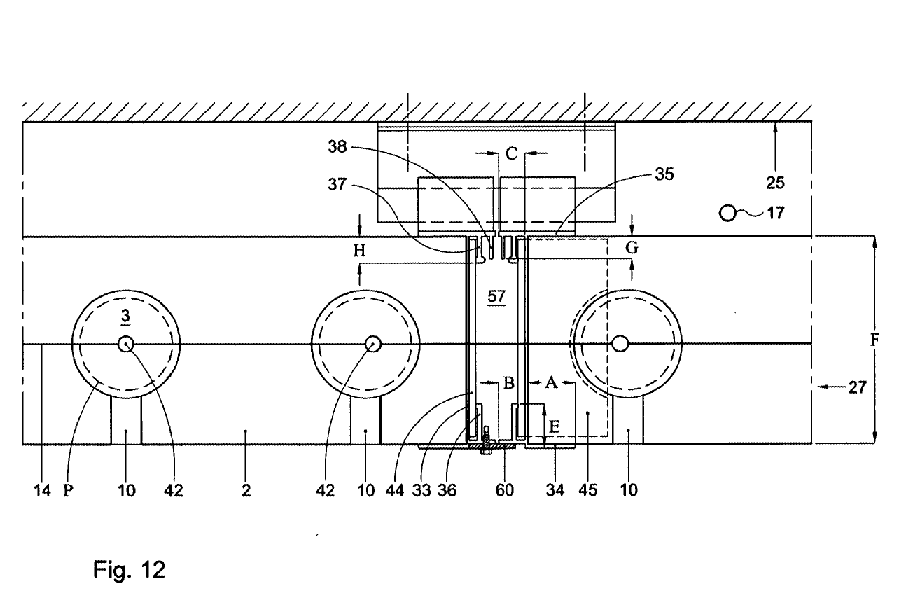

FIG. 12 shows, in cross sectional top plan view according to the line XII-XII in FIG. 11, a part of a wall;

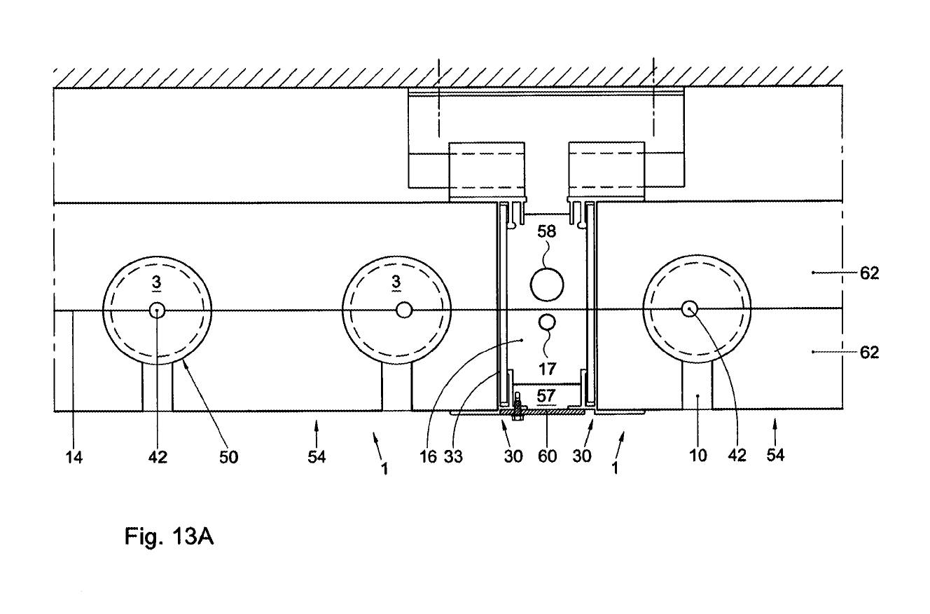

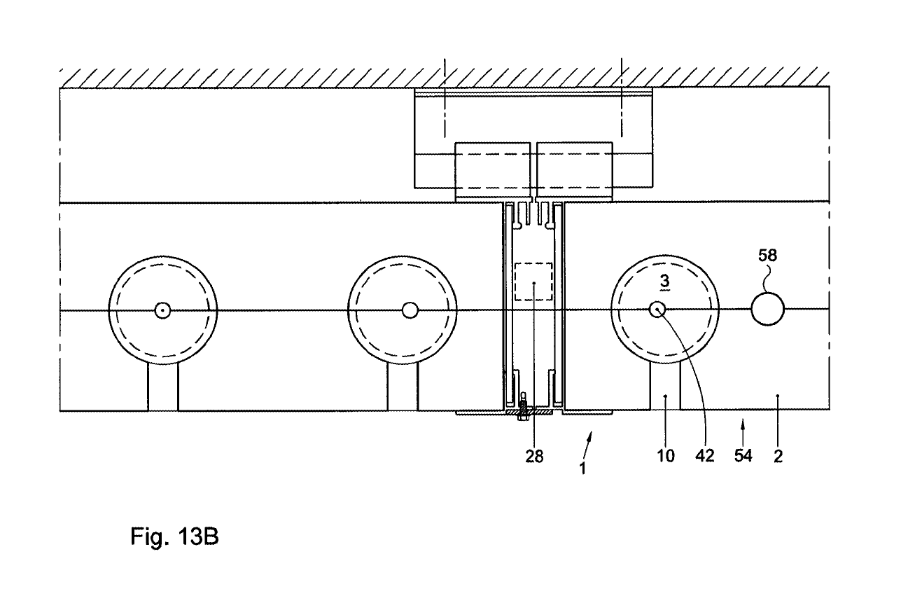

FIGS. 13A and B show two alternative embodiments of a part of a wall, in cross section along the line XII-XII in FIG. 11;

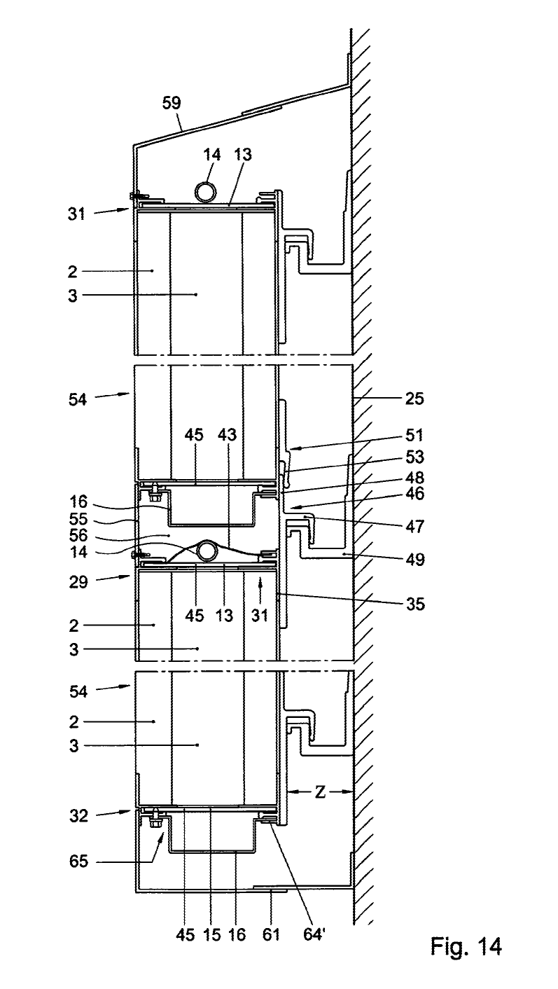

FIG. 14 shows, in cross sectional side view, a wall with growth devices; and

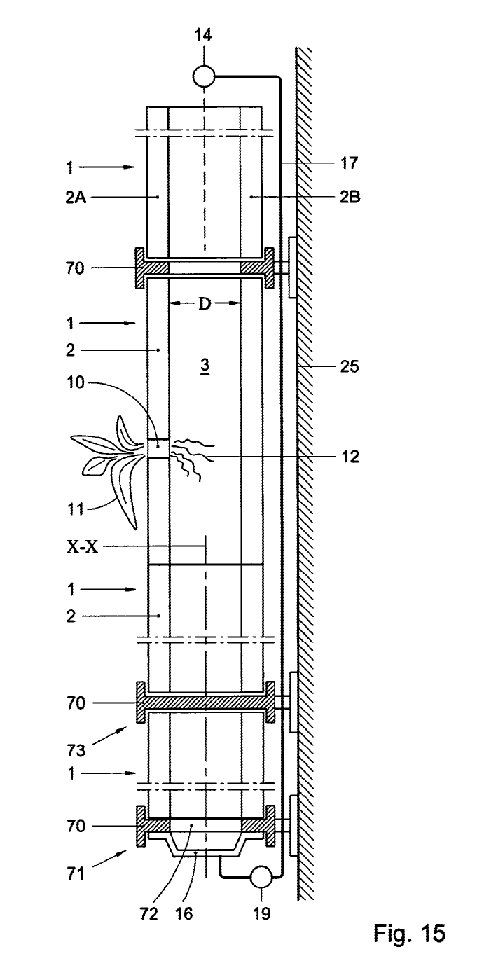

FIG. 15 shows, in cross sectional side view, a part of a column, built up with growth devices.

The embodiments shown in the drawing are shown merely by way of illustration and should not be construed to be limitative in any manner. In the Figures, identical or corresponding parts have identical or corresponding reference numerals.

In FIGS. 1 and 2, an embodiment of a growth device 1 according to the invention is shown. FIG. 1 shows in front view, and FIG. 2 shows in cross sectional side view, a growth device 1, comprising a casing 2 and a core part 3. The core part 3 is substantially surrounded by the casing 2. In this embodiment, the casing 2 is manufactured from a substantially fluid impermeable material, such as foamglas, polystyrene, polyurethane (PUR), polyisocyanurate (PIR) plastic such as polyester (PET), polyethylene (PE), polyvinyl chloride (PVC) and the like materials. The casing 2 may also be hydrophobic. The core part 3 is preferably manufactured from or comprises a growth medium. In one embodiment, the core part 3 can be manufactured from a mineral wool, such as rock wool, with water retention capacity. The core part 3 can be manufactured from, for instance, rock wool with hydrophilic properties. In another embodiment, the core part 3 can be manufactured from rock wool with water retention properties which are at least higher than the water retention properties of the casing 2. In another embodiment, the core part can for instance comprise soil, turf, oasis, coco or another growth medium. Furthermore, mixtures of growth mediums can be provided in or as core part 3. The growth medium can also comprise a mixture of natural and synthetic materials. In one embodiment, a core or core part 3 can be manufactured from a growth medium mixed with a foaming agent or binder, so that a relatively form-retaining core is obtained. To that end, for instance a curing synthetic can be used, such as polyurethane, or a glue.

In the embodiment shown in FIGS. 1 and 2, the growth device 1 has substantially a block shape with a first end 4 and an opposite, second end 5, a first side 6, an opposite second side 7, a third side 8 and an opposite fourth side 9. During use as shown in FIGS. 1 and 2, the first end 4 is for instance a top side, the opposite second end 5 a bottom side. Here, the third side 6 can for instance be a front and the fourth side 7 a rear side. Naturally, the specific position of the different ends 4, 5 and sides 6, 7, 8, 9 depends on the positioning of the growth device.

In one surface of the growth device 1, in the casing 2, openings 10 can be provided which preferably reach adjacent, to and/or into the core part 3. In the openings, plants 11 or other crop can be inserted, such that roots 12 can grow in and/or against the core part 3 and can withdraw water and nutrients therefrom, while the crop 11 can grow along an outside of the casing 2. In the embodiment shown, openings 10 are provided in the first 6 and the second side 7. However, the openings can also be provided in only one side or, conversely, in several sides. The openings 10 can be provided during manufacture of the growth device, but can also be provided upon provision of the crop 11. The openings 10 can also be provided as cuts in the casing 2, which can be pulled open when placing the crop 11. The crop 11 can for instance be placed in plugs of rock wool in the openings 10 or directly into a core part 3.

In and/or adjacent the first end 4, at least one water supply opening 13 is provided, through which the core part is accessible to water. Herein, water is understood to include at least but not exclusively pure water or another medium, preferably liquid, from which the crop can extract nutrients. Above the at least one water supply opening 13, a water supply line 14 is provided. In and/or adjacent the opposite second end 5, at least one water discharge opening 15 is provided. Through it, water can be discharged from the core part 3. As the casing is substantially, and preferably completely watertight, water fed into the core part 3 will not be able to flow away through the casing 2 and will therefore be taken up by the crop 11 in the openings 10 or flow in the direction of the water discharge opening 15. A collecting element 16, such as a channel is provided adjacent the at least one water discharge opening 15, for collecting water flowing from the water discharge opening. Water return means 17 are provided for returning the water from the collecting element 16 to the at least one water supply opening 13. To that end, the water return means 17 can comprise a line 18, connected to the water supply line 14, and a pump 19. Furthermore, a buffer barrel 52 can be provided as shown in FIG. 3. A control device 20 can be provided with which water supply to the core part can be controlled, for instance over time and/or in amounts. Water can thus be recirculated within the growth device 1 and/or an assembly thereof.

The casing 2 can for instance be assembled from two or more parts, for instance two parts being recessed for enclosing a core part 3 or part thereof. The parts are placed around the core parts 3 with the recesses facing each other, whereupon they have been attached to each other. To that end, coupling means can be utilized, or a housing as will be described in the following. Naturally, other divisions are possible too.

FIG. 8 schematically shows, in cross sectional side view, a variant of a growth device according to, for instance, FIGS. 1 and 2, wherein the openings 13 and/or 15 can extend over the thickness D of the core 3 while furthermore, the openings 13 and/or 15 can extend over the width B of the core, or at least over a significant part of the thickness D and/or width B, for instance more than 50% thereof. The water discharge opening 15 can then be open, if the growth medium of the core parts 3 is sufficiently form-retaining, but can also be covered with a cover 40, for instance a skin, gauze, cloth or the like, through which water can pass but the growth medium cannot. Preferably, the cover 40 can be grown through by roots. Through it, roots 12 of the crop 11 can grow from the growth device 1, for instance into a core part 3 of a core part 3 linking up with the water discharge opening 15 of another growth device 1 or for instance into the soil or another surface 41 with which the water discharge opening 15 is in communication. As a result, the roots 12 of the crop 11 can start extracting water and growth substances therefrom, so that watering via for instance the water supply openings 13 becomes less necessary or can even be omitted.

FIG. 10 shows a further embodiment, wherein a series of core parts 3 are provided side-by-side. In this embodiment, the growth device 1 comprises a block of fluid impermeable material, such as polyurethane which forms the casing 2. From one end 5, a number of holes 50 are formed, side by side with, for instance, parallel longitudinal axes. The holes 50 extend to a distance from an opposite end 4, for instance to adjacent half the height of the block. Openings 15 can be provided which extend from the end of the holes 50 into the opposite end 6. These openings 15 can form water supply openings. Plants 11 are placed through a wall of the block into the core parts 3, so that roots 12 can grow therein and therethrough, for instance into the ground 41, so that they can extract water and nutrients from the soil. Furthermore, the plants need grow only half the height H of the block 1 for obtaining a full covering. The fact is that a part of the plants can grow upward and another part downward. As a result, the growth device will be covered sooner.

A device according to for instance FIG. 10 can be formed by drilling or otherwise forming the holes 50 in the block, then fill the holes turned upside down with growth medium such as soil, mineral wool, coco, oasis, peat, burlap or another known growth medium. Preferably, in growth devices according to the invention, use is made of growth medium with a relatively high water capacity and retention capacity, such as for instance soil. If for instance mineral wool is utilized, preferably, a retention means is added. After the holes 50 have been filled, a covering 40 can be provided over the respective end 5, as discussed earlier, after which the block can be turned over, with the covering downward, whereupon the plants 11 can be provided. To that end, for instance openings 10 can be arranged in one or several sides of the device 1. In a further embodiment, poles 52 can be inserted through holes 50 and be forced for instance into the ground 41, so that a self supporting wall can be obtained. Also, specific slots or holes can be provided for such poles. Such a solution with poles offers the advantage that a series of growth devices 1 can be coupled or linked, without sound leaks forming. Here, the mineral wool, such as rock wool, provides sound-proofing.

In the embodiments shown, the growth device 1 can be provided with a housing 21. The housing 21 can be provided against at least two opposite sides 5, 6 of the casing 2. In one embodiment, the housing 21 can comprise two elements 22, one on each side 5, 6, mutually connected by coupling means 23 such as bolts and nuts, wire elements, clamps or other means for connecting the two elements. In this embodiment, the other two sides 7, 8 can be virtually clear of the housing. In another embodiment, the housing 21 can for instance be substantially tubular and extend around the four sides 5-8. The housing 21 is preferably provided with openings 24, for instance perforations or mazes. In one embodiment shown, the housing 21 can be built up substantially from gauze. The openings 24 are then formed by the mazes in the gauze. The openings 24 can for instance be approximately as large as or larger than the openings 10. In another embodiment, the openings 24 are smaller than the openings 10. In yet another embodiment, the openings 24 and/or the openings 10 are of different sizes. Crop 12 can reach through the openings 24. The crop can for instance grow between the casing 2 and the housing 21 and/or along the outside of the housing 21. When the housing 21 is built up from gauze, the crop can use the wires thereof as support and/or guide. The housing 21 offers support to the casing 2 and the core part 3. Furthermore, the housing can be used for fastening the growth device 1 to for instance a façade, construction part, other growth device 1, support or other external element. In another embodiment, the openings 24 can be provided as perforations, such as shown in, for instance, FIG. 4.

In yet another embodiment of the growth device according to the invention, the housing 21 may also comprise a layer of granulated material or stony material that is attached to at least one outer surface of the casing 2. Such a layer may provide nice aesthetic properties and at the same time may provide a suitable bonding surface for specific plants due to the surface structure of said layer. The layer may also contribute to an improved micro climate for the plants. Also other kinds of suitable materials may be used for providing the housing, for instance on at least on outer surface of the casing, dependent on the functional properties of the housing. For instance, the casing may be of material with good insulating properties and the housing, for instance at one outer surface of the casing, may comprise a panel of a material that has such properties that it can be easily attached to a wall, for instance to an inner wall of a building. The panel can be of any suitable material depending on the intended use thereof. Also combinations of materials can be used to form the housing.

In FIG. 3, different growth devices 1 are fastened against a façade 25. In the façade 25, an opening 26 is provided, for instance a window. At the right hand side thereof, two growth devices 1 one above the other are shown, while schematically in interrupted lines, core parts 3 are provided which extend in a meandering manner between a water supply opening 13 and a water discharge opening 15. The water discharge opening 15 of the top growth device 1 links up with the water supply opening 13 of the bottom growth device 1. At the left hand side, two growth devices are provided having a rectangular shape from which a corner is taken. As a result, these two growth devices 1 can enclose the window 26 and link up with the two remaining growth devices 1. These growth devices can be provided in a similar manner with core parts forming channels between a water supply opening 13 and a water discharge opening 15. In the embodiment shown, in the growth devices shown on the left hand side, each time, two water supply openings 13 and two water discharge openings 15 are provided, with as many connecting channels, formed by the core parts 3. Naturally, in a comparable manner, also other shapes of growth devices can be made and utilized, for instance for surrounding other façade elements such as windows, doors, roof edges, balconies and the like or for forming for other reasons irregular or regular forms of assemblies of several growth devices 1.

In FIG. 3, only by way of illustration, the growth device 1 shown at the left hand bottom side is provided with the housing 21, for simplification, which growth device 1 is furthermore provided with crop 11. Naturally, also the other growth devices shown can be provided with a housing and/or crop.

In FIG. 3, water return means 17 are provided for returning water from the discharge openings 15 to the water supply openings 13. Again, water can be recirculated through the different growth devices 1. Naturally, in another manner too, supply and/or discharge of water can be ensured, for instance by using rain water, without recirculation and/or with water supply lines extending through the growth devices 1, in particular through and/or along the core parts. The casing 2 ensures insulation, for instance sound proofing and/or heat insulation. As a result, the core parts 3 and in particular moisture therein can furthermore be insulated from the façade. The growth devices 1 can extend vertically, but can also be provided in another position, for instance on an inclining plane such as a roof surface or a slope. The growth devices 1 can be flat, such as shown in FIGS. 1 and 2, but can also be curved in one or several directions.

In FIG. 4, a wall 27 is built up with growth devices 1, placed between poles 28, 52. The wall 27 can for instance be a sound wall. Here, the casings 2 ensure sound proofing, while further, the wall can take up pollution such as CO₂ and/or fine dust, in particular when water flows therethrough.

FIG. 5 shows, in top plan view, an alternative embodiment of a growth device 1, wherein six core parts 3 extend side by side, mutually separated by parts 2A of the casing 2. The core parts 3 can for instance be straight and extend between water supply openings 13 and water discharge openings 15. Naturally, in a comparable manner, other numbers of core parts and/or forms of core parts 3 with matching casings 2 can be utilized.

FIG. 6 shows, in cross sectional front view, a growth device 1, with core part 3 and casing part 2, with the core part 3 extending in a meandering manner between the water supply opening 13 and the water discharge opening 15. Water will thus flow through less rapidly than when the core parts are straight.

FIG. 7 shows a further alternative embodiment of a growth device 1, wherein a core part 3 manufactured from a growth substrate such as rock wool with water retention capacity is provided adjacent a bottom side, while a part 2 manufactured from fluid impermeable material, for instance polyurethane, is placed thereabove. Again, a housing 21 is provided on at least two opposite sides 6, 7 for confining it, and providing firmness and stability of the growth device 1, also when the core parts 3 are moist, comparable to the action of the casing 2 in the earlier described embodiments. Such a device can offer a particularly good sound proofing and a large surface for guiding crop.

FIGS. 9A and 9B show embodiments of a growth device 1 according to the invention which is suitable in particular but not exclusively for use on flat and inclining surfaces such as roofs, slopes, road sides, banks and the like. In this embodiment, the casing 2 comprises a somewhat tray-shaped part manufactured from a fluid impermeable material such as foamglas, polyurethane, polystyrene, polyisocyanurate, plastic such as polyester, polyethylene, polyvinyl chloride or the like materials, with a first side 6 forming a bottom. Here, the first and second end 4, 5, and the third and fourth side 8, 9 form an upstanding edge which surround the or different core parts 3. The second side 7 can be open (see FIG. 9B), but can also be covered by a covering 42, such as a fleece, gauze, foil, plate or the like in which or through which crop 11 with roots 12 can be arranged in the or a core part 3 (see FIG. 9A). The covering can but needs not be such that roots can grow through it and is preferably, but not necessarily, water transmissive. Again, in the first end, water inlet openings 13 can be provided and/or in the second end water discharge openings 15. In an earlier shown manner, several of such growth devices can be put next to each other and/or one above the other such that water inlet openings 13 are brought into fluid communication with water discharge openings 15 and water can flow further from one growth device into another growth device. The covering 42 can form part of the casing 2 or can be provided as separate covering.

The embodiment of the growth device 1 as shown in FIG. 9B is particularly suitable to be used on a flat and inclining surface such as a roof R. In FIG. 9B, an assembly of multiple growth devices 1 is shown. The respective growth devices 1 are in fluid communication such that water can flow from one of the core parts 3 into the other core parts 3 that are arranged downstream thereof. The growth devices 1 are positioned adjacent to each other such that the water discharge openings 15 of an upstream growth device 1 are situated opposite of the water inlet openings 13 of a downstream growth device 1. The bottom 6 of the casing 2 is provided on the roof surface R. The respective growth devices 1 are mutually connected, for instance by means of a suitable adhesive such that the interconnections between neighbouring growth devices are fluid impermeable as well. Fluid, such as rain water or water flowing through subsequent core parts 3 is prevented from draining in between the roof surface R and the bottom 6 of the casing 2. The core part 3 preferably is a form-retaining core, for instance obtained by mixing a suitable growth medium with a binder or the like as described with FIG. 1. Due to such a form-retaining core, the growth device comprising said core can be transported and handled without the need of special packaging of the device 1. Furthermore, in case the growth device 1 is used on an inclining surface (see FIG. 9B), the form-retaining core prevents that small particles of the core material may flow downstream due to water flowing through the core 3. The pore size and pore distribution within the form-retaining core may remain constant. Consequently, accumulation of particles at a downstream end of the growing device 1 is prevented, thus a continuous water and air flow within the core part is maintained.

A casing 2 according to the invention is preferably manufactured from a substantially fluid impermeable material. Herein, this is understood to include at least but not exclusively a material having a structure which is at least impermeable to fluids such as water, but at the same time may have other properties such as heat insulating properties. Furthermore, the material is preferably sound absorbing. The casing or parts thereof can for instance be foamed directly into the desired form, while the outer layers may form a skin with, for instance, a greater density than a material located therebetween. The material can also first be formed into blocks, mats, strips or the like, whereupon recesses are provided, for instance through milling, cutting or similar operations, and/or through local compression, for including core parts 3 or parts thereof. By way of illustration and not limitative, as examples of material of which the casing 2 can be manufactured foamglas, polystyrene, polyurethane and polyisocyanurate can be given. These are materials with a high heat capacity, so that the roots of crop planted in the core parts are well protected both from dehydration and from, for instance, freezing.

The core parts 3 can be provided with means for regulating the flow velocity of water through the core parts 3. Water retention means for instance, such as gel, can be utilized in at least parts of the core parts, for delaying flow. Alternatively or additionally, the cross section of the core parts can be varied, the density of the core parts can change, for instance increase in the direction towards the water discharge openings 15, a capillary action of the growth medium in the core parts 3 can be adjusted and/or the form of the core parts 3 can change in the direction of the water discharge openings, in particular be more meandering.

In FIGS. 11-14, embodiments of a wall 27 are shown, while growth devices 1 are provided. Here, a wall 27 is built up from substantially plate-shaped growth devices 1 set in frames 29. Each frame 29 comprises, for instance, two side profiles 30, a bottom profile 32 and a top profile 31. In the example shown, in each frame 29, for instance two growth devices or panels 1 are placed one above the other and confined. The sections 30-32 are preferably extrusion profiles, manufactured from, for instance, aluminum, an aluminum alloy or plastic, although other materials are possible too, such as wood or composite. In this embodiment, each growth device 1 can be designed according to one of the preceding Figures. In the embodiment shown, it is comparable to that according to FIG. 5, wherein the cores 3 can have a substantially circular cross section, such as shown in FIGS. 12 and 13. The cross section can for instance be the same, increase or decrease over the entire height H in the direction of one or both ends 4, 5. The cores 3 can also have irregular cross sections, and/or other than circular. The cores in a growth device 1 can have the same shape or even be identical but can also mutually differ. The cores 3 are of growth agent or substrate, as described hereinabove, while the casing 2, preferably as described hereinabove, is fluid impermeable. The cores 3 can be ventilated via the plant openings 10 or via additional micro through holes, while water is held in the cores or can escape from the cores only through holes intended to that end. In general, to the growth of plants, ventilation is very important.

In these embodiments, the or each core 3 can extend from a first end 4 into a second end 5. In an alternative embodiment, on one or both the ends 4, 5, a plug P can be provided, for instance for confining the core 3 while it can be watered and/or dewatered through the plug. The casing 2 can also be formed such that the core 3 is confined therein, while it can still be watered and dewatered through openings 13, 15 above and below the core 3.

In the embodiment shown, for each of the profiles 30-32 a profile with the same cross section is used, so that costs are reduced. In this embodiment, in cross section, the profile has a wall 33 with, on both sides, a first and as second transverse wall 34, 35, respectively. The transverse walls 34, 35 extend from a first side of the wall 33 over a first distance A and on the opposite second side over a distance B, C, respectively. On the second side, on the first transverse wall 34, a first profile element 36 is provided with extends approximately parallel to the wall 33, over a width E, smaller than the width F of the wall 33, in the direction of the second transverse wall 35. The second transverse wall 35 is provided on the second side with a second profile part and a third profile part 37, 38 extending approximately parallel thereto, which profile parts extend approximately parallel to the wall 33, in the direction of the first transverse wall, over a width G, H, again smaller than the width F of the wall 33. In each corner of the frame 29, a corner element 39 is provided, schematically represented in FIG. 11, which is clamped with a first leg 44 between the wall 33 and the first or second profile part 36, 37, respectively, of a side section 30, and by a second leg 45 between the wall 33 and the first or second profile part 36, 37, respectively, of a bottom profile 31 or top profile 32, respectively. As a result, a relatively rigid and bearing frame is obtained. The legs 44, 45 can be secured in the sections 30, 32, for instance through clamping, welding, gluing or other connecting techniques.

As can be seen in FIG. 14, on the top side 4 of the growth devices 1, at least on the top side of the frame 29, on the top profile 31, a water supply line 14 in the form of a watering hose with nozzles or small holes 42 is provided. In the profile 31, above each core 3, an opening 13 is provided, for instance through drilling or cutting in the wall 33, above which a nozzle or small hole 42 extends above the opening 13, for supply of water. The water supply line 14 is pressed against the profile 29 with the aid of clips 43. The clips 43 can for instance be clamped on one side between the leg 45 and the wall 33 and on the other side between the second and third profile part 37, 38. As a result, the line 14 is well confined and still easily detachable, for instance for maintenance. Below the bottom section 32, a channel profile or collecting element 16 is provided. This channel profile 16 is inserted by a first longitudinal edge 64 between the second and third profile part 37, 38. An opposite longitudinal edge 65, which during use, will lie at the front of the wall, is detachably connected with the respective profile 32, for instance through bolts or screws, so that maintenance and cleaning of the channel 16 is possible in a simple manner. In a wall 33 of the bottom profile 32, below each of the cores 3, a discharge opening 15 is provided, for instance through drilling or cutting. Water coming from the core 3 at the bottom side will therefore flow through the openings 15 into the channel 16. The channels 16 can extend along the bottom of several panels 54.

The growth devices 1 are confined between the section 30-32, with the first and second transverse profile lying against a front and rear side, respectively, of the casing 2.

On the second transverse wall 35 of the top profile 31 or a side profile, a hook 46 can be provided at an outside, adjacent each top corner of the frame 29. In one embodiment, the hook 46 can form part of the profile 30 or 31. In another embodiment, the hook 46 can be fastened through, for instance, gluing or welding or with the aid of other connecting means such as for instance but not limited to, screws, bolts, blind rivets, clamping means and the like. The hook 46 has a hook element 47 open towards the bottom and has a flange 48 on a top side. On a façade 25 of a building or other wall, profiles or hook elements 49 can be fastened over which the hook element 47 of the hook 46 can be hooked, so that the frame 29 with the growth devices 1 can be suspended from the façade 25, preferably at a distance Z thereof. The distance Z can for instance be a few millimetres to some decimetres and enables for instance ventilation of the facade 25 and the rear side of the growth devices 1. Adjacent the bottom profile 32, for instance adjacent bottom corners of the frame 29, support elements 51 can be provided, for instance fastened to or integral with one of the profiles 30, 32. The support elements 51 comprise a downward directed hook element 53 that can fall over the flange 48 of an underlying hook element 45, for confining the respective panel 54 at least in one direction, formed by at least the respective growth device or growth devices 1 and the surrounding frame 29. In one embodiment, the hook profile 45, at least the flange 48 can indeed move slightly upward in the support element 51, so that an underlying panel 54 can be moved upwards and can be tilted to be removed or placed.

As appears from FIG. 14, the profiles 31, 32 of two neighbouring panels 54 are held at a distance from each other. A sealing profile 55 can be provided on the front which seals the space 56 which has formed through this distance. This sealing profile 55 is preferably detachable so that channels 16 and lines 14 lying therebehind can be approached for, for instance, maintenance. Furthermore, with this, relative tolerances in positions of the panels can be provided and compensated, as can deformations, for instance through expansion and shrinkage.

In FIG. 12, in cross sectional top plan view, a portion of a wall 27 is shown, before a façade 25. Clearly visible are the cores 3 with thereabove the drippers or holes 42, represented by circles, connected by the lines, represented in lines. In this embodiment, four cores 3 are provided per growth device 1, which extend for instance vertically, parallel to each other and the façade. Openings 10 extend from the front through the casing 2 as far as or into the cores 3, so that plants 11 (not shown) can be provided therein and roots 12 can form in the cores. The casing 2 can prevent roots 12 from growing through the casing, for instance towards the rear, so that the façade 25 is protected. Water will seep from the line 14 through the cores and, as far as it is not consumed, will be collected in the channel. From the channel 16, it can be returned by the earlier described water return means 17 to the water supply line 14. Between adjacent panels 54, a space 57 is kept open which, again, can be covered at the front by a sealing profile 60.

In FIG. 13A, a part of an embodiment is shown wherein between two panels 54 in the space 57 therebetween a standpipe 58 is provided which can for instance be connected to one or more channels 16 of panels. As a result, water which has collected in the channels can simply be discharged and optionally be reused. A filtering device can be included in the water return means 17 of the exemplary embodiment shown, as can supply means for, for instance, fertilizer and other aggregates.

In FIG. 13B, an alternative embodiment is shown, wherein a part of a standpipe 58 is included in one or several growth devices linking up with each other. With adjoining or abutting panels 54, this will result in standpipes that can ensure water discharge from the channels 16. Here, the casing 2 can form the part of the standpipe but also, for forming this, a pipe can be laid in or inserted in the growing direction.

In FIG. 14, at the top side, a cap 59 is provided which at least partly seals the top side of the wall construction from rain coming in and other weather conditions. At the bottom side, a second cover cap 61 is provided. On both sides, in a comparable manner, a sealing cap can be provided so that the surroundings of the growth devices can be conditioned to some extent, in any case at the rear side.

Growth devices 1 shown here can be manufactured from, for instance, two pieces 62 of fluid impermeable material, such as foamglas, polystyrene, polyurethane or the like, while channels can be recessed in surfaces that are to abut against each other. As a result, the holes 50 are formed in which the cores 3 can be provided. They can for instance be laid in before the plates are laid against each other or be inserted into the openings 50 at a later stage. The respective plates 62 can be manufactured from different materials or material properties. For instance, the plate located at the rear can be fluid impermeable and the plate at the front may be gas permeable and hydrophobic. Also other insulating properties can be provided, and the panels can be designed to be self-supporting. The panels 54 can also be designed such that they can be stacked without being fastened to a façade. Uprights or poles 28 can then be inserted through the spaces 57, which poles can be anchored to the ground 41 or to a built element.

FIG. 15 shows a portion of a column, built up with growth devices 1. In this embodiment, each growth device 1 comprises a cylindrical pipe-shaped dish as casing 2, for instance built up from two dish parts 2A, 2B. In it, a core is included. The casing 2 and core 3 are, again, manufactured from materials as mentioned hereinabove for casings or cores, respectively. The core 3 can for instance have a cross section D of a few centimetres to a few decimetres. Preferably, the cross section is relatively large, for instance some decimetres. In one embodiment, the diameter can for instance be between approximately 20 and 30 cm, for instance between 20 and 25 cm, such as for instance 23 cm. The dish parts of the casing 2 can for instance have a thickness of a few centimetres, for instance between 2 and 10 cm. With a core 3 having a diameter of approximately 23 cm, the dish may have a wall thickness of approximately 4 cm. These dimensions are mentioned merely by way of illustration.

In the embodiment of FIG. 15, a growth device 1 is placed by one end 71 on a support ring 70, with a longitudinal axis X-X approximately vertically. Herein, approximately is understood to include that the longitudinal axis can include an angle with the vertical as long as water, poured adjacent a top side onto or into the core will penetrate into the core and, as far as it is not used or retained by the core 3, will flow out at the opposite side. The support ring 70 is fastened to a carrier, for instance a façade 25, and is provided with an opening 72 below the core 3. On the opposite second end 73, a second and possible subsequent growth device 1 can be placed, having the cores in communication with each other. Above one growth device 1, a second support ring 70 may be fastened to the façade 25, on which, again, a growth device can be borne. Therefore, the cores 3 of growth devices thus stacked into a column and borne by support rings 70 form a core continuous over at least a height and preferably completely continuous, while, again, at a top side water can be introduced by supplying it to the core 13, water can be collected at the bottom side and be returned to the top end. In the casings 2 of the growth devices 1, again, plants 11 can be placed in openings 10 that continue to adjacent or to the cores 3.

With a growth device 1 or wall or column or other element built or clad therewith, for instance moistening lines can be included in the cores, heating and/or cooling lines can be provided in or adjacent the cores and/or the casings, for keeping, for instance, the growth medium frost free and sensors can be provided with which for instance the temperature and humidity of the cores and/or the surrounding can be measured, while a control device can be provided with which, for instance in a known manner, a watering regime can be set and/or adjusted.

The invention is not limited in any manner to the embodiments represented in the drawing and the specification. Many variations thereon are possible within the framework of the invention as outlined by the claims. This includes at least also all possible combinations of parts of the growth devices shown. Also, for instance growth devices 1 can be utilized where core parts are provided next to each other as well as behind each other, in two or more layers side by side, while the casing can extend at least partly therebetween.

1. A growth device for crop, provided with at least a casing and a core part, wherein the casing, at least a part of the casing enclosing the core part, is manufactured from a substantially fluid impermeable material and surrounds the at least one core part at least partly, wherein the core part comprises a growth medium or is formed therefrom.

2. A growth device according to claim 1, wherein the casing is substantially water-repellent.

3. A growth device according to claim 1, wherein the casing is substantially manufactured from at least one of foamglas, polystyrene, polyurethane, polyisocyanurate, plastic such as polyester, polyethylene, polyvinyl chloride and the like materials.

4. A growth device according to claim 1, wherein the casing is substantially manufactured from stone, concrete, clay or the like material, wherein the part of the casing enclosing the core part is provided with a layer of fluid impermeable material.

5. A growth device according to claim 1, wherein at least one wall of the casing is provided with at least one opening which extends to near and/or into the at least one core part.

6. A growth device according to claim 5, wherein the at least one opening is a through hole, wherein a central axis of the through hole extends at an angle with respect to the casing wall such that in use a first end of the through hole facing away from the core part is located above a second end of the through hole facing the core part.

7. A growth device according to claim 1, wherein the casing comprises at least two parts which are placed against each other, thereby at least partly enclosing the at least one core part.

8. A growth device according to claim 1, wherein the at least one core part comprises mineral wool, in particular hydrophilic mineral wool.

9. A growth device according to claim 1, wherein the at least one core part comprises a mixture of a growth medium, such as soil, turf, oasis coco or the like medium, and a binder, such as a curing synthetic or an adhesive.

10. A growth device according to claim 1, wherein the casing is partly surrounded by a housing, wherein the housing is provided with openings.

11. A growth device according to claim 10, wherein the housing can comprise a different material than the casing, for instance a gauze, perforated plate, a plate of granulated material, a plate of stony material or a plate of any other suitable material.

12. A growth device according to claim 1, wherein the at least one core part on at least one side lies clear of the casing.

13. A growth device according to claim 1, wherein water supply means are provided in or adjacent the at least one core part.

14. A growth device according to claim 1, wherein a top side and a bottom side are provided, wherein adjacent the top side at least a part of the at least one core part is accessible to water and wherein at the bottom side at least one water discharge opening is provided for discharge of water from the at least one core part, wherein return means are provided for returning to the core part, adjacent the top side, water collected at the water discharge opening.

15. A growth device according to claim 1, wherein in the casing, crop is provided, of which at least a part of the roots reach as far as and/or into the core part.

16. An assembly of at least two growth devices according to claim 1, wherein the core parts of the respective growth devices are in communication with each other such that water can flow from one of the core parts into at least one other core part.

17. A cladding or construction part, comprising at least a growth device according to claim 1, or an assembly according to claim 16.

18. A construction part comprising a core part, manufactured from a substrate which can retain water, and a portion of substantially fluid impermeable material which is sound absorbing and water-repellent, wherein a housing is provided which covers and confines at least the portion of the fluid impermeable material and the core part at least at two opposite sides, and is provided with openings.

19. A method for the manufacture of a growth device, wherein a core part is manufactured from a somewhat hydrophilic material, which core part is at least partly surrounded by a casing which is at least partly manufactured from a substantially fluid impermeable material.

20. A method according to claim 18, wherein the casing is built up from at least two parts which are provided around the core part.

21. A method according to claim 19, wherein around the casing, a housing is provided, provided with openings, in particular a housing manufactured from gauze, perforated plate, a plate of granulated material and/or a plate of stony material.
